(19) United States
(12) Patent Application Publication
(10) Pub. No.: US 2026/0350125 A1
(43) Pub. Date: Nov. 5, 2026

(54) ONLINE MONITORING SYSTEM AND METHOD OF USE

(71) Applicant: Hilario Nava, Fort Worth, TX (US)

(72) Inventor: Hilario Nava, Fort Worth, TX (US)

(21) Appl. No.: 19/244,079

(22) Filed: Jun. 20, 2025

Related U.S. Application Data
(63) Continuation of application No. 18/977,501, filed on Dec. 11, 2024, now abandoned.

(51) Int. Cl. G06F 21/31; G06Q 10/40

(52) U.S. Cl. CPC G06F 21/31; G06Q 10/40

(57) ABSTRACT

A method to determine whether an interaction on various social media platforms constitutes spamming. The method includes providing a computer with a program associated with a web server; assigning an actual online identity similar to a virtual identification card to a user via the computer; authenticating that the user is a real person; activating the program via the computer and thereafter tracking user interactions on a plurality of social media platforms; tracking of a score and an activity assigned to the user via the program; utilize the score to determine a user value; and determining if spamming is occurring based upon the user valve.

### BACKGROUND

### 1. Field of the Invention

The present invention relates generally to online monitoring systems.

### 2. Description of Related Art

Surfing the internet and socializing with various persons via one or more social media platforms is well known in the art and rapidly increasing as a leisure activity. For example, FIG. 1 depicts a conventional process 101 wherein a user 103 utilizes a computer 105 to access and socialize on various social media platforms 107, 109, 111 and so forth. During the session, the user may like, dislike, comment, and perform other social interactions with other third parties via the social media platforms. It should be understood that the user 103 could exhaust considerable time and energy building a profile and forming bonds between various parties on the social media platforms.

One of the problems commonly associated with process 101 is that the tracking of the user's activities on the social media platforms are not being tracked. Such tracking of activities could benefit the user 103. For example, the user 103 may wish for a job as a social media expert and has little to show for the amount of time and energy exhausted on the various social media platforms.

Accordingly, there is a need for a tracking means to monitor activity of the user and to provide third parties with the value of the user's activities.

### DESCRIPTION OF THE DRAWINGS

The novel features believed characteristic of the embodiments of the present application are set forth in the appended claims. However, the embodiments themselves, as well as a preferred mode of use, and further objectives and advantages thereof, will best be understood by reference to the following detailed description when read in conjunction with the accompanying drawings, wherein:

FIG. 1 is a simplified schematic of a conventional process to utilize social media platforms;

FIG. 2 is a simplified schematic of a social media tracking system and method of use in accordance with a preferred embodiment of the present application;

FIG. 3 is a tracking table of the system of FIG. 2;

FIGS. 4 and 5 are simplified schematics of a communications network of the system of FIG. 2; and

FIG. 6 is a flowchart of the preferred method of use.

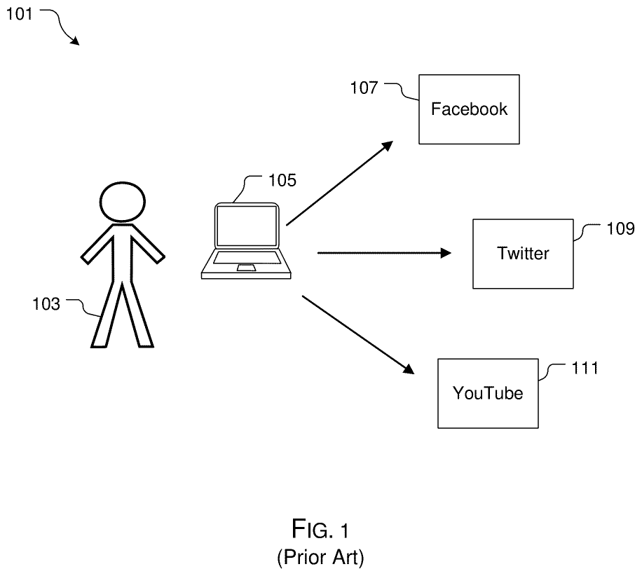

While the system and method of use of the present application is susceptible to various modifications and alternative forms, specific embodiments thereof have been shown by way of example in the drawings and are herein described in detail. It should be understood, however, that the description herein of specific embodiments is not intended to limit the invention to the particular embodiment disclosed, but on the contrary, the intention is to cover all modifications, equivalents, and alternatives falling within the spirit and scope of the present application as defined by the appended claims.

### DETAILED DESCRIPTION OF THE PREFERRED EMBODIMENT

Illustrative embodiments of the system and method of use of the present application are provided below. It will of course be appreciated that in the development of any actual embodiment, numerous implementation-specific decisions will be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The system and method of use in accordance with the present application overcomes one or more of the above-discussed problems commonly associated with conventional processes of utilizing various social media platforms. Specifically, the system and method of the present application provides rapid and effective means to track the interaction and activity of the user for one or more social media platforms and to assign a score for other parties to determine the user's value. These and other unique features of the system and method of use are discussed below and illustrated in the accompanying drawings.

The system and method of use will be understood, both as to its structure and operation, from the accompanying drawings, taken in conjunction with the accompanying description. Several embodiments of the system are presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless described otherwise.

The preferred embodiment herein described is not intended to be exhaustive or to limit the invention to the precise form disclosed. It is chosen and described to explain the principles of the invention and its application and practical use to enable others skilled in the art to follow its teachings.

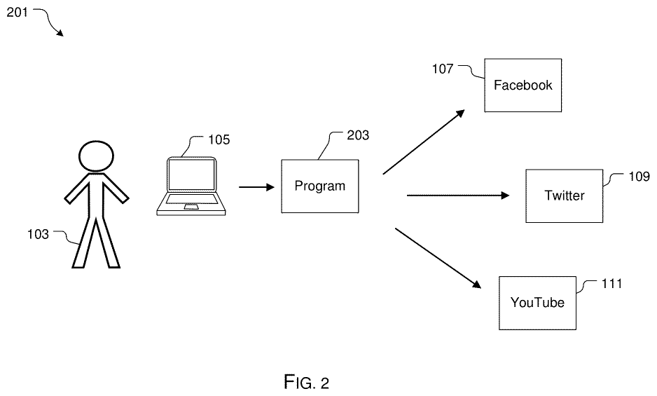

Referring now to the drawings wherein like reference characters identify corresponding or similar elements throughout the several views, FIG. 2 depicts a simplified view of a tracking system and method of use in accordance with a preferred embodiment of the present application. It will be appreciated that system 201 overcomes one of more of the above-listed problems commonly associated with the conventional usage of social media platforms.

In the contemplated embodiment, system 201 includes one or more of a program 203 uploaded on computer 105 and configured to monitor the user's interaction with the various social media platforms 107, 109, and 111. Although shown solely with three different types of social media platforms, it will be appreciated that other platforms are known in the art and are hereby included for determining the user's score.

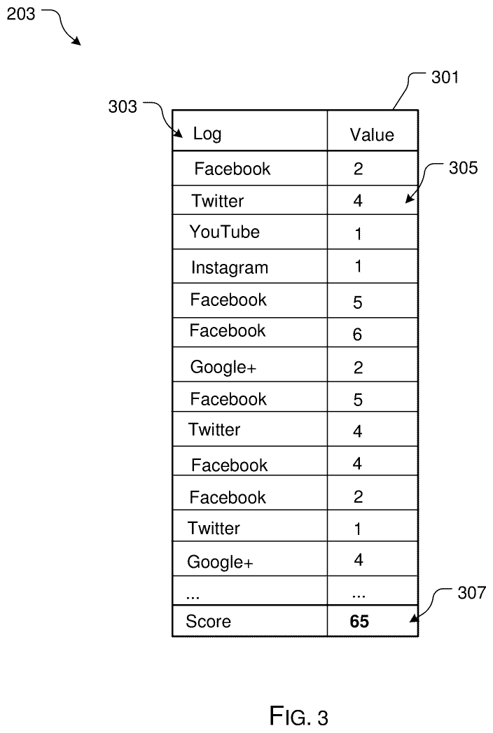

It should be understood that the program 203 is configured to determine various factors of the user's interaction with the social media platforms. FIG. 3 is a basic table 301 created by the program 203 for tracking the user's interaction with the social media platforms. The table 301 could include one or more of a log history 303 of the various social media platforms visited by the user and thereafter assign a value 305 for the activities performed, e.g., likes, posts, and other forms of interactions. The values are tabulated via an algorithm associated with program 203 to assign a score 307. Various factors are associated with assigning a score to the user's interactions with the social media platforms. It is contemplated and will be appreciated that the score 307 could comprise the audience of the social media interactions by demographic or geographic means. It is also contemplated that a monetary value for social interactions could be included as part of the score 307 or assigned based on the score 307.

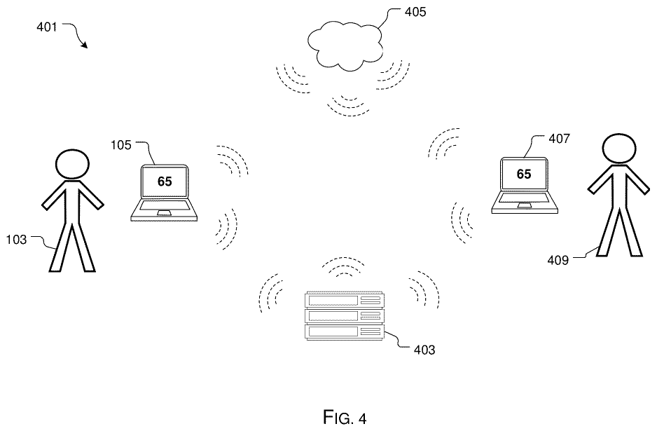

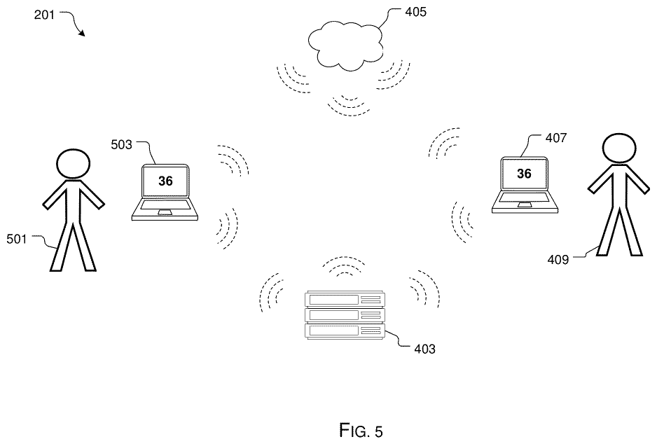

In FIGS. 4 and 5, a general schematic of the communication system 401 associated with program 203 is shown. It will be appreciated that the score created by the user 103 could be readily available to third parties. This feature is achieved via a database 403 and/or internet service provider 405 in communication with a third party 409 via computer 407.

Accordingly, it should be appreciated that system 201 provides means for third parties 409, e.g., a potential employer, to access the worth of hiring user 103 by the score. This feature could be of value to an employer attempting to hire employees with extensive interaction of the various social media platforms. It should be understood that various employers seek employees that are well familiar with the social media platforms for marketing purposes. The features of system 201 provides means for the employers to determine the user's worth.

In FIG. 5, an alternative use of system 201 is shown. It will be appreciated that system 201 could also be configured to determine whether the interaction on the various social media platforms constitutes spamming by user 501 via computer 503. The user 501 may attempt to utilize the various social media platforms through extensive use and multiple posts, like, and other interactions in a short duration of time that would in turn harm the user's score. For example, the user 501 may attempt to promote their business and the website associated with the business. The system completed herein would assign a score to the URL website, which in turn is relayed to the third party 409. The third party could stop all interaction with user 501 with a filtered score below a determined threshold value. It will be appreciated that in this way program 203 and score 307 could function as a virtual means of identification like a social security number or a birth certificate, e.g. linking a user's multiple email addresses or social media platform logins to a verified person. It is contemplated that program 203 could also function as a username or access code to validate the user to a third party or other online presence.

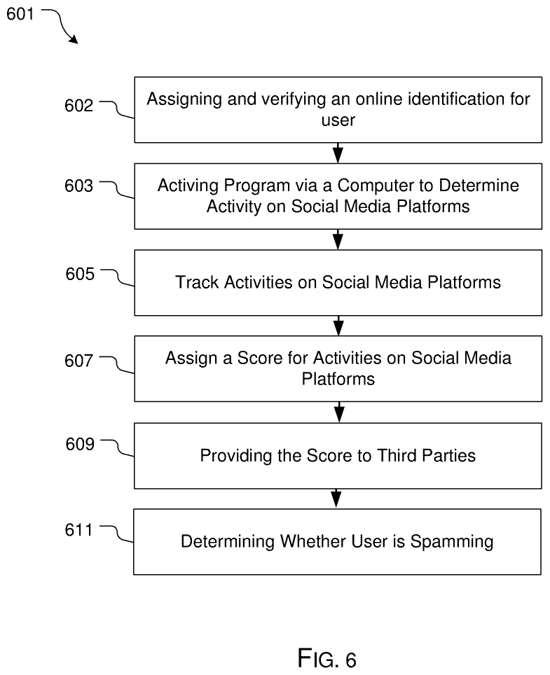

Referring now to FIG. 6, a flowchart 601 depicting the preferred method of use is shown. The first step includes the process of assigning an actual online identity similar to a virtual identification card to the user, as depicted in box 602. The online identify will allow tracking of the score and activity assigned to the user. In one embodiment, the application will give a score along with authenticating that the user is a real person. Also, this process prevents third parties from making fake profiles. The method includes the process of activating the program via a computer and thereafter tracking the user's interactions on the various social media platforms, as depicted in boxes 603, 605. Thereafter, the program is configured to assign a score based upon the interaction of the user and to provide the score to third parties, as depicted in boxes 607, 609. The third party can then utilize the score to determine the user's value or to determine if spamming is occurring, as depicted in box 611.

The particular embodiments disclosed above are illustrative only, as the embodiments may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. Although the present embodiments are shown above, they are not limited to just these embodiments, but are amenable to various changes and modifications without departing from the spirit thereof.

1. A method to determine whether an interaction on various social media platforms constitutes spamming, the method comprising:
providing a computer with a program associated with a web server;
assigning an actual online identity similar to a virtual identification card to a user via the computer;
authenticating that the user is a real person;
activating the program via the computer and thereafter tracking user interactions on a plurality of social media platforms;
tracking of a score and an activity assigned to the user via the program;
utilize the score to determine a user value; and
determining if spamming is occurring based upon the user valve.
